(19) United States
(12) Patent Application Publication
(10) Pub. No.: US 2012/0257921 A1
(43) Pub. Date: Oct. 11, 2012

(54) Liquid fluid applicator device

(76) Inventor: Gerardo Strobl Diener, Monterrey (MX)

(21) Appl. No.: 13/506,176

(22) Filed: Apr. 2, 2012

(30) Foreign Application Priority Data
Apr. 8, 2011 (MX) MX/A/2011/003768

(51) Int. Cl. A46B 11/00; B05C 17/00

(52) U.S. Cl. 401/129; 401/126; 401/130

(57) ABSTRACT

The liquid fluid applicator device described includes an applicator head and a container body. The applicator head is a separate piece defined by a support base that decreases gradually to form a tubular portion or collar, and gradually increases to define a distributor body base to which adheres at least one distributor body. The container body is defined by a tubular portion or neck which extends gradually and defines in the contour of its diameter a carrier base for holding the contour of the support head base. From the carrier base, the body extends to define the geometry of the container body. The applicator head is removable for individual use for diverse applications, such as in the cosmetic industry to release liquid soap, body lotion and even facials.

### FIELD OF THE INVENTION

The invention relates to articles that carry or distribute liquid fluid, such as liquid soap, paste, toothpaste or the like. The invention provides an applicator device of liquid fluids comprising an applicator head and a body fluid container, where the liquid in the container body is dispensed towards the applicator head in a predetermined dose and then is removed completely from the container body, whereby it can be used independently.

### BACKGROUND OF INVENTION

In the state of art there are various devices for applying liquids for personal use, which comprise a container body and a head-type device, whose function is to dispense the contents of the container body. For example, U.S. Pat. No. 4,035,090 describes an applicator which consists of a reservoir, which has two pads to apply the liquid, semi-liquid or pasty substance contained within the reservoir, where the mechanism for applying the liquid is a kind of piston, which is actuated by placing a sort of cap at the bottom of the applicator, and exerting pressure on it. This device differs from the invention in that the liquid fluid applicator of the present application includes an application head which is removable, and the dispensing mechanism is simple and does not require a piston, but rather operates by pressure exerted by a user dispensing the liquid content and the dosage is adjusted by the opening of the outlet orifice. Also, U.S. Pat. No. 5,577,851 entitled “Tube Dispenser With Sponge Applicator” describes a dispensing tube which has an applicator sponge assembled to the open end of the dispensing tube but is not removable, so that the sponge applicator can not be used independently and in use for cleaning and washing, in conjunction with the dispensing tube, runs the risk of product contamination. U.S. Pat. No. 6,887,007 entitled “Hand-Held Body Washing Device” describes a portable device with a handle, which has a sponge-like material, and a space for solid soap as well as an additional reservoir to contain liquid soap. This reservoir functions as a dispenser and has an inlet and an outlet. Although this device shares certain features of the liquid fluid applicator device of the invention, it differs from the invention in that liquid soap which is stored in the container body reaches the material distributor due to pressure exerted by a user on the container body, instead of being provided through gravity. Additionally, the application device of the invention has a removable applicator head.

An applying lotion device is shown in U.S. Pat. No. 6,129,469, which is intended to apply or distribute a lotion or any liquid fluid in body parts that are difficult to reach. This device is one piece and has in the inside a reservoir for the fluid to be dispensed. One of its ends has a distributor head attached to the remainder of the device through whose openings lotion is dispensed as the user presses a pump located in the inside of the device. The main differences of the liquid fluid dispensing device of the invention is that the distributor head is removable from the rest of the container body, besides that the form of dispensing the liquid contents is through pressure exerted by a user to the container body, without the need for any additional mechanism within the device.

### SUMMARY OF THE INVENTION

The liquid fluid applicator device of the invention includes an applicator head and a container body.

Particularly, the applicator head is a single piece defined therein by a first portion, referred to as support base, that decreases gradually to a tubular portion or collar, and then gradually increases to define a second portion of the body called a distributor body base to which adheres at least one distributor body. For its part, the container body is defined by a tubular portion or neck extending gradually and defining in the contour of its diameter a carrier base for holding the contour of the support head base, and from that carrier base the body extends to define the geometry of the container body. A peculiarity of the applicator device is that its applicator head is removable for separate use for diverse applications, such as in the cosmetic industry to release liquid soap, body lotion and even facials.

### BRIEF DESCRIPTION OF THE DRAWINGS

The following detailed description of specific non-limiting embodiments of the present invention can be best understood when read in conjunction with the following drawings, where like structures are indicated with like reference numbers.

FIG. 1 is a partial front view of the distribution head removed from the body.

FIG. 2 is a perspective view of the distribution head held by a user.

FIG. 3 is a front view of the liquid fluid applicator device with the distribution head attached to the container body.

FIG. 4 is a partially transparent view of the distribution head showing inside structure by dotted lines.

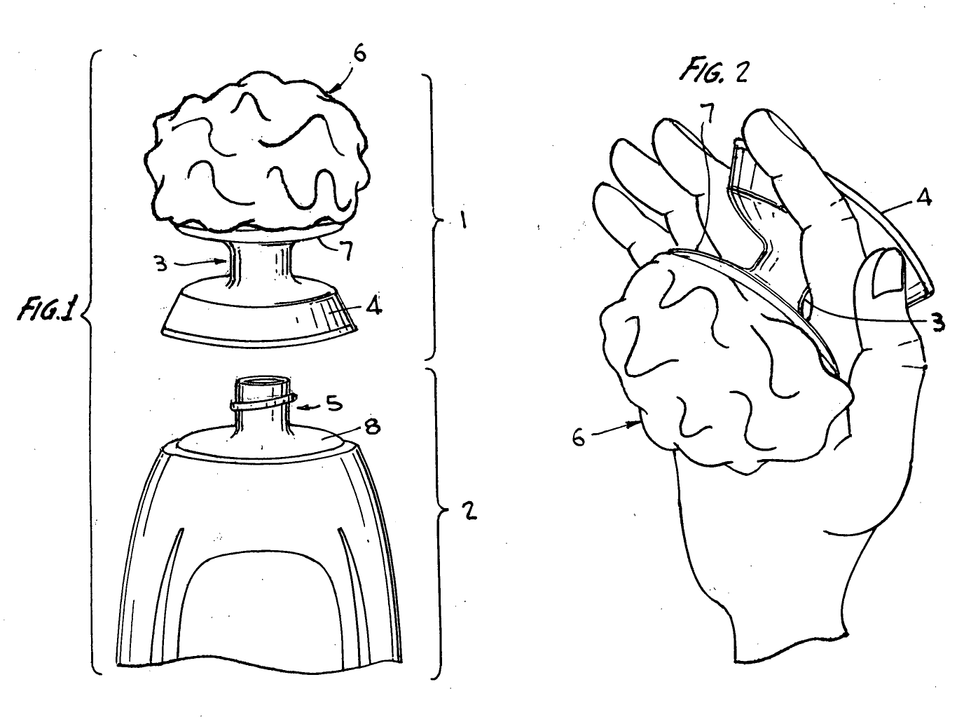

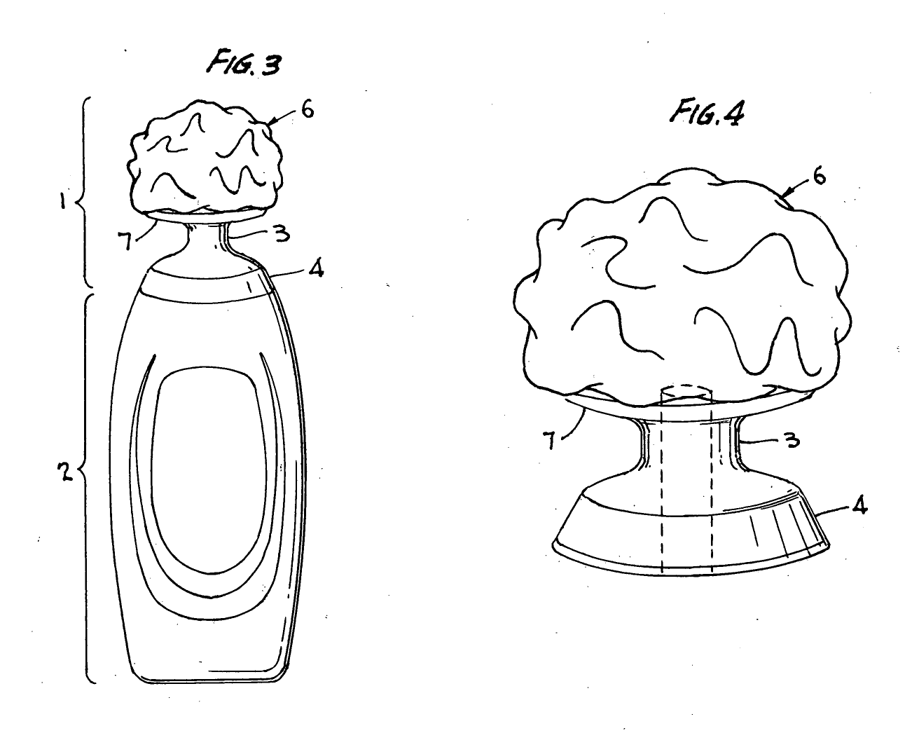

### DETAILED DESCRIPTION OF THE INVENTION

The liquid fluid applicator device with controlled dosing comprises two main parts: an applicator head (1) and a container body (2). The applicator head (1) is composed of a single piece which is completely removable from the container body (2), and therefore washable to prevent accumulation of residue. The applicator head (1), including its interior, is defined by:

a first portion or support base (4) which presents a cross-section or width which gradually decreases upward to define a cavity and coincide with one end of

a tubular section or collar (3), preferably having an interior manufactured with a rigid polymer, such as acrylonitrile-butadiene-styrene copolymer (ABS), and subsequently the free end of the collar extends to

a second portion or distributor body base (7) which extends in length presenting a cross-sectional circular, elliptical or polygonal geometry, ending with a flat surface of circular, elliptical or polygonal geometry, which forms an angle to the perpendicular axis of the container body in a range from its origin up to 180°, with at least one outlet for the liquid contained in the container body (2), to the flat surface is attached at least

a distributor body (6).

The cavity defined by the support base (4) allows the applicator head to be assembled to the container body, particularly through the coupling of an external surface of the upper portion of the container body (2), in the cavity, so that in the inside the collar portion (3) articulates with the portion defined as the neck (5) of the container body. Optionally, the joint is a threaded mechanism.

It is noted that the support base (4) is a soft polymer, such as silicone or polypropylene plastic, to provide better handling and ergonomics to the user during use since the support base (4) serves as a handle.

Typically, the union of distributor body (6) with the flat portion of the base of the distributor body (7), is provided by mechanical elements, such as clips, staples or stitching, although thermal means, such as radio frequency or ultrasound bonding, by flame or heat application, or chemical means such as adhesives, are also suitable for use.

Differently, the distributor body (6) is selected from at least one of the structures described in (a)-(d) below.

(a) Brush bristles, which are optionally:
Metal, such as copper or brass,
Plastic polymers, such as polyethylene or polypropylene, and
Animal or vegetable origin.

(b) Sponges that optionally are polyester, polyurethane, polyvinyl acetal, rubber latex or cellulose. The sponge comprising the distributor body (6), optionally is processed by behavior modification techniques of physical characteristics such as compresses, mainly reticulated, by presenting such sponges with a density of at least 10 kg/m³ to 300 kg/m³, which may be provided using a foaming process of at least 10 pores per 2.54 cm² to 7000 pores per 2.54 cm².

(c) Textiles selected from natural fibers, such as cotton, silk, and the like; synthetic fibers, such as polyester, nylon, extruded plastic such as polypropylene, polyethylene, or the like; or a combination of at least two of the fibers above, where fabrics are optionally woven or nonwoven, flat or circular, preferably shaped with threads which are non-corrosive upon contact with water, and wherein the threads have at least one filament of 0.1 to 2000 denier.

(d) Extruded plastic selected from at least one of the following: terephthalate, polyethylene terephthalate, generally known as PET or Polyethylene Terephthalate; polyester, nylon; cotton; rayon; polypropylene; bamboo; microfiber; and the like.

The container body (2) is defined by a tubular portion or neck (5), which coincides in height and width with the collar (3) of the applicator head (1). The collar (3) covers the neck (5), optionally in threaded form, so to open and close the container body (2), allowing complete removal of the applicator head (1) for independent handling. The collar (3) also has in its interior, an open channel that extends to the outlet port located at the base of the distributor body (7), allowing through it, the passage of fluid liquid in the container body (2) to the distributor body (6). After the neck (5), the container body (2) gradually extends and defines an area called carrier base (8), which fits together with the cavity of the support base (4) and maintains or continues the contour thereof. From carrier base (8), the body extends to define the geometry of the container body (2). Liquid fluids that may optionally be contained by the container body (2) are pseudo-plastics, cellulose, grease, soap, paint, ink, latex solution, and emulsions, among others. The size of the liquid fluid applicator device will be based on the industrial application of the device and the fluid contained therein.

Below are some examples of the performance and preferred application of the liquid fluid the applicator device.

### Example 1

An applicator device for a polish liquid fluid for the care or maintenance of furniture, such as red oil, where in particular the applicator head has an outlet opening toward the distributor body that is of cotton microfiber fabric, with polyester reticulated foam base density of 20 kg/m³, attached with adhesive to the lid.

### Example 2

Applicator device of liquid fluid such as paint, polish (such as Armor All®), plastics protector, among other automotive products, in particular where the distributor body is a polyester sponge with a density of 45 kg/m³, attached to the flat part of the applicator head second portion by radio frequency, and its application is as an article for the care and maintenance of plastic or metal surfaces of a vehicle.

### Example 3

Applicator device of liquid fluid such as liquid soap, in particular where the applicator body is a sponge made of extruded polyethylene sheeting which has an aperture of 5 mm between nodes, attached by stitching to the flat part of the second portion of the head applicator, and its use is as a cleaning article for personal care.

Other industrial applications include—

Home cleaning devices, particularly for kitchen surfaces, shoes, clothing, glass;

Applicator device of liquid fluids such as paint or crafts coating or construction;

Applicator device of liquid fluids for pet care and cleaning;

Applicator device of liquid fluids for the care and cleaning of carpets and upholstery, among others.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

It is claimed:

1. A liquid fluid applicator device with controlled dosing comprising:
(a) an applicator head and
(b) a container body
wherein the applicator head is a separate piece including a support base having a width which gradually decreases to form a cavity and match one end of a first tubular collar portion, a distributor body base that starts at a free end of the collar portion and defines a surface that binds to at least one distributor body; and wherein the container body includes a second tubular collar portion which extends in one direction to define a carrier base which fits together with the cavity of the support base and extends in another direction to define geometry of the container body.

2. The applicator device according to claim 1, wherein the applicator head is removable from the body container.

3. The applicator device according to claim 1, wherein the applicator head is washable.

4. The applicator device according to claim 1, wherein the support base rests on the carrier base, and from said carrier base extends a carrier body which defines the geometry of the container body.

5. The applicator device according to claim 1, wherein the support base is made of a soft polymer.

6. The applicator device according to claim 5, wherein the soft polymer is a silicone plastic or a polypropylene plastic.

7. The applicator device according to claim 1, wherein the support base of the distributor body has a circular, elliptical or polygonal shape.

8. The applicator device according to claim 1, wherein the support base of the distributor body has a flat surface which joins the distributor body and is located at an angle to a perpendicular axis of the container body in a range from origin up to 180°.

9. The applicator device according to claim 1, wherein union of the distributor body to the support base of the distributor body is by a mechanical structure.

10. The applicator device according to claim 1, wherein union of the distributor body to the support base of the distributor body is provided by a thermal connection.

11. The applicator device according to claim 10, wherein the thermal connection is through radio frequency, ultrasound, flame, or heat application.

12. The applicator device according to claim 1, wherein union of the distributor body to the support base of the distributor body is provided by a chemical connection.

13. The applicator device of claim 12, wherein the chemical connection is by an adhesive.

14. The applicator device according to claim 1, wherein the distributor body is composed of a material selected from the group consisting of at least one of a bristle brush, sponge, textile and extruded plastic.

15. The applicator device according to claim 14, wherein bristles of the bristle brush are selected from copper or brass brush bristles, polyethylene or polypropylene brush bristles, and vegetable or animal origin brush bristles.

16. The applicator device according to claim 14, wherein the sponge is composed of polyester, polyurethane, polyvinyl acetal, rubber latex, or cellulose.

17. The applicator device according to claim 14, wherein the sponge has a density of at least 10 kg/m³ to 300 kg/m³, including at least 10 pores per 2.54 cm² to 7000 pores per 2.54 cm².

18. The applicator device according to claim 14, wherein the sponge is compressed or reticulated.

19. The applicator device according to claim 14, wherein the textile is selected from natural fibers, synthetic fibers, or a combination thereof.

20. The applicator device according to claim 14, wherein the textile is woven or nonwoven, flexible, flat or circular with at least one thread filament of 0.1 to 2000 denier.

21. The applicator device according to claim 14, wherein the textile is flexible and comprises threads which are non-corrosive upon contact with water.

22. The applicator device according to claim 19, wherein the synthetic fibers are extruded plastics selected from the group consisting of at least one of terephthalate, polyethylene terephthalate, polyester, nylon, rayon, polypropylene, and microfiber.

23. The applicator device according to claim 1, wherein the distributor body has at least one outlet for the liquid contained in the container body.

24. The applicator device according to claim 1, wherein the first tubular collar portion coincides in height and width with the neck of the container body, and covers the neck in threaded form to close and open, allowing complete removal of the head applicator for independent handling from the container body.

25. The applicator device according to claim 1, wherein the first tubular collar portion includes interiorly an open channel extending to an outlet port located in the distributor body.

26. The applicator device according to claim 1, wherein the applicator head has at an upper end thereof at least one distributor body.

27. The applicator device according to claim 1, wherein the applicator device is constructed and arranged to dispense a liquid fluid which is pseudo-plastic, cellulose, grease, soap, paint, ink, latex solution, or emulsion.
